(19) United States
(12) Patent Application Publication
(10) Pub. No.: US 2018/0200942 A1
(43) Pub. Date: Jul. 19, 2018

(54) PROCESS AND ASSEMBLY FOR CREATING A THIN LAYER FLEXIBLE MEMBRANE, SUCH AS ATTACHABLE TO A FRAME OR OTHER RIGID OUTER SUPPORT

(71) Applicant: U.S. Farathane Corporation, Auburn Hills, MI (US)

(72) Inventor: Steve Porter, Romeo, MI (US)

(21) Appl. No.: 15/840,226

(22) Filed: Dec. 13, 2017

Related U.S. Application Data
(60) Provisional application No. 62/448,080, filed on Jan. 19, 2017.

(51) Int. Cl. B29C 51/08; B29C 51/18; B29C 51/42

(52) U.S. Cl. CPC B29C 51/082; B29L 2031/755; B29C 51/42; B29C 51/18

(57) ABSTRACT

The present invention teaches an assembly and corresponding method for producing a plastic part having a sandwich mold including an upper half and a lower half. Each of the halves exhibit an opposing inner face which, upon assembling, collectively define an interior cavity corresponding to a configuration of the part to be produced. An insert sheet of a polymer material (typically a thermoplastic at room temperature) is placed upon a lower of the mold halves and prior to assembling the upper mold half. A heat source is communicated to the closed mold to cause the insert sheet to melt into the cavity. A cool source is subsequently communicated to the closed mold to cause the thermoplastic to harden within the cavity and prior to opening of the mold and removal of the finished part.

### CROSS REFERENCE TO RELATED APPLICATIONS

The present application claims priority from U.S. Ser. No. 62/448,080 filed Jan. 19, 2017.

### BACKGROUND OF THE INVENTION

### Field Of The Invention

The present invention relates generally to a plastic membrane or flap, such as which is attached to supporting frame or module associated with such as a ventilation module. More specifically, the present invention discloses an assembly and corresponding process for forming a flap or membrane style part (including the production of a part having any of a thin, flexible or other property) using any type of closable mold for containing an extruded sheet of polymer material. Heated platens are applied for melting the extruded sheet in order to fill a cavity defined between the molds, following which the mold is transferred to between a pair of cold platens, following which the polymer material is caused to solidify. Once sufficiently cooled, the mold is opened and part removed concurrent with scraping away of any remaining trim flashing.

### Background of the Invention

The prior art is documented with various types of compression molding techniques, assemblies and articles for producing any type of plasticized component not limited to rigid panels, softer flap designs or the like. A first example of this is shown in Rule, U.S. Pat. No. 7,431,875 which teaches a process of preparing a unitized membrane electrode assembly using compression molding and including the steps of forming a multilayer sandwich having a first gas diffusion backing having sealing edges, a first electro-catalyst coating composition, a polymer membrane, a second electrocatalyst coating composition and a second gas diffusion backing having sealing edges.

Additional steps including compression molding a sealing polymer to the multilayer sandwich, wherein the mold used in the compression molding apparatus further includes a frame part with a hole through its center, a bottom plunger and a top plunger; wherein the plungers are fabricated to fit substantially snuggly in the hole in the frame part, and wherein at least one plunger comprises at least one low-thermal conductivity insert. The sealing polymer is impregnated into at least a portion of the sealing edges of the first and second gas diffusion backings, and the thermoplastic polymer envelops a peripheral region of both the first and second gas diffusion backings and the polymer membrane to form a thermoplastic polymer, fluid impermeable seal.

Also referenced is Hartmann U.S. Pat. No. 3,101,944 which teaches a method for molding a synthetic resin product and including articles molded of conventional synthetic thermoset or thermoplastic resins obtained by conventional molding procedures, such as pressure-molding, casting, injection molding, etc., as may be applicable to a particular resin, and using conventionally known thermosetting or thermoplastic molding materials.

Further noted is the mold and process for creating thin walled articles (e.g. data. discs) set forth in U.S. Pat. No. 7,279,122 to Bareisch and which teaches molten plastic injected into mold parts forming a thin cavity, such as in a cyclic molding process wherein the mold parts are subjected to a substantially constant temperature stimulus and rise and fall in temperature during injection and cooling of the molten plastic. Temperature boosting thermal insulation layers are placed along at least certain parts of the molding cavity surface, and which elevates the temperature of the molted melt material for a time during injection. According to a calculated relationship, this thermal insulation is sized to permit the thin mold cavity to fill before heat transfer to the mold parts solidifies the molding material and blocks further flow, and with the temperature boosters being contoured in thickness.

### SUMMARY OF THE PRESENT INVENTION

The present invention teaches an assembly and related method for producing a plastic part having a sandwich mold including an upper half and a lower half. Each of the halves exhibit an opposing inner face which, upon assembling, collectively define an interior cavity corresponding to a configuration of the part to be produced.

An insert sheet of a thermoplastic (typically room temperature) is placed upon a lower of the mold halves and prior to assembling the upper mold half. A heat source is communicated to the closed mold to cause the insert sheet to melt into the cavity. A cool source is subsequently communicated to the closed mold to cause the thermoplastic to harden within the cavity and prior to opening of the mold and removal of the finished part.

The upper and lower mold halves each further exhibit locating projections and recesses for aligning the halves during closing along hinged side edges. The heat source further includes a pair of upper and lower heating platens which are placed against exterior surfaces of the mold halves, and the cool source likewise includes a pair of upper and lower cooling platens subsequently placed against exterior surfaces of the mold halves.

Additional features include at least one of the upper and lower mold halves further including an overfill channel in communication with the cavity. Beyond the use of thermoplastic sheets, it is further envisioned that other materials including but not limited to expandable foam or other polymeric materials

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a thin plastic part, such as which can be produced by a conventional injection molding process;

FIG. 2 is an illustration of a two piece sandwich type compression mold according to one non-limiting design of the present invention and including opposing interior profiles which, upon closing, mimic the shape of a thin plastic part to be produced, such as shown in FIG. 1;

FIG. 3 is a succeeding illustration to FIG. 2 and illustrating an extruded sheet of material which is placed within the lower half of the opened mold and upon its interior profile;

FIG. 4 is an illustration of the mold of FIG. 3 being successively closed, by any of manual or automated fashion in which the upper half is brought into opposing and abutting contact with the lower half and thereby sandwiching the extruded sheet therebetween, following which the mold is supported between a pair of upper and lower heated platens;

FIG. 5 is a successive illustration of the mold being transferred to between a successive pair of upper and lower cooled platens which, upon the extruded sheet previously having been melted into a filling condition with the interior defined cavity, causes the material to solidify;

FIG. 6 is a subsequent mold open condition in which the mold is opened and the part removed, such as following excising of scrap including trim flashing; and

FIG. 7 is an illustration of a thin plastic part, similar to as shown in FIG. 1, and such as which can be produced by sandwich mold process of the present invention.

### DETAILED DESCRIPTION OF THE PREFERRED EMBODIMENTS

As will be further described with reference to the attached illustrations, the present invention discloses a mold process for creating a plastic membrane or flap, such having a varying thickness (can be thin, flexible, semi-flexible/semi-rigid, rigid or otherwise) and which can be attached to supporting frame or module associated with such as a ventilation module. As previously described, such flaps or membranes have been previously produced according to such as a plastic injection molding process, which the sandwich mold process of the present invention seeks to improve upon by creating a simplified, cost effective and non-obvious way to inexpensively produce a suitable plastic flap which can be integrated into a suitable ventilation airflow module or the like.

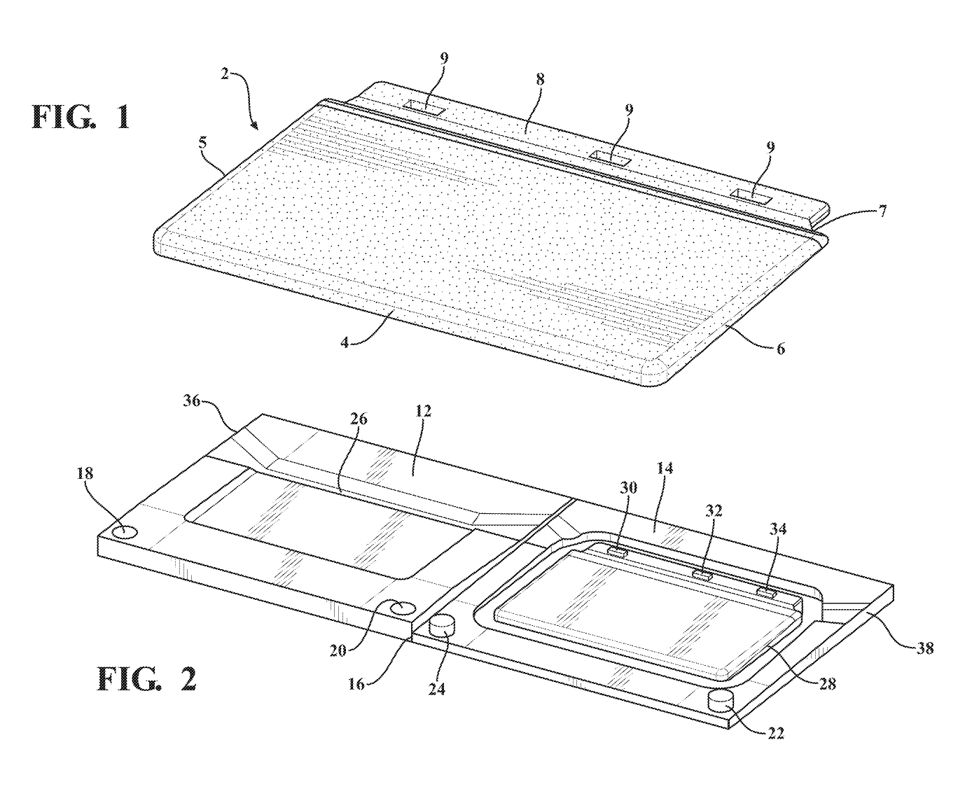

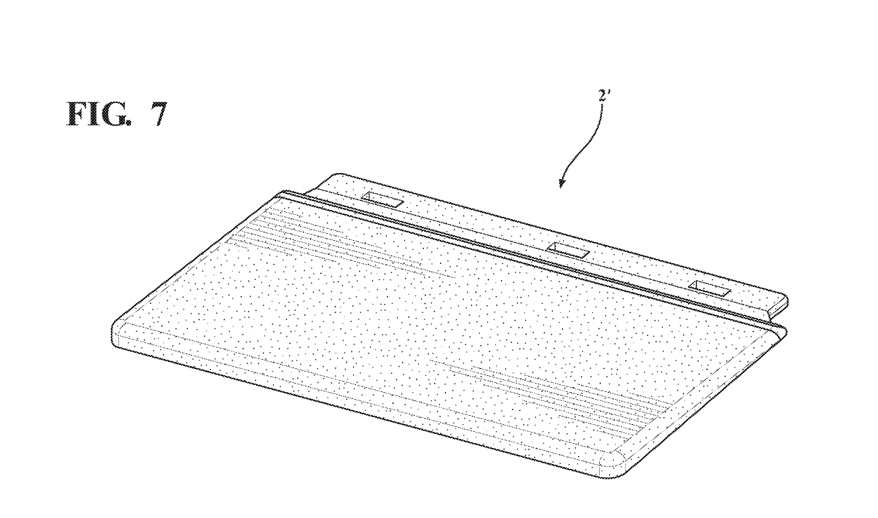

Referring to FIGS. 1 and 7, these each being substantially identical for purposes of the present description, an example of a membrane 2 is shown having a generally rectangular and three dimensional configuration with a most-thickened back edge 4, progressively forward extending and thinning side edges 5 and 6 (these corresponding to a gradual thinning of the body along its width defined between the side edges) and a modified forward most edge. As further shown, the forward edge includes an intermediate surface profile 7, from which further extends in a partially offset fashion a flap 8 with locating or set-off details 9 formed therein.

Although not shown, the membrane 2 is designed to be secured to such as a hard rigid frame or outer support, such associated with an airflow communicating component associated with a vehicle ventilation system of the like. In this design, the membrane is secured either by fasteners or adhesives (or via a controlled mechanical or chemical melt process) to an inner defined edge of the module associated with a passageway aperture, and so that the membrane is caused to pivot (by virtue of the airflow) between an opened or a closed/sealed condition relative to the aperture.

As is further described, such existing membranes are often produced via an injection molding process, such often resulting in internal stresses induced into the part and as a result of the molten injected molded plastic contacting a cold mold/tool surface, and which can be reflected in curling or warping of the finished product or variations in the final shape of the part when exposed to elevated temperatures (such as associated with environmental operating conditions). A further factor associated with existing injection molding processes includes the relatively high expense of the injection mold process and tooling.

The present invention, as reflected in attached FIGS. 2-6, seeks to overcome the cost and product variation disadvantages associated with injection molded membranes by the sandwich mold process of the present invention. More specifically, the present invention discloses a flap formed using a foldable sandwich mold for containing an extruded sheet of polymer material. Without limitation, the polymer/thermoplastic material can also include any solid, liquid or granular material which can also include expandable foams.

Heated platens are applied for melting the extruded sheet in order to fill a cavity defined between the molds, following which the mold is transferred to between a pair of cold platens, following which the polymer material is caused to solidify. Once sufficiently cooled, the mold is opened and part removed concurrent with scraping away of any remaining trim flashing.

Given the above explanation, reference is initially made to FIG. 2 of an illustration of a two piece sandwich type compression mold, generally at 10, according to one non-limiting design of the present invention. The mold 10 includes a first upper half 12 and a second lower half 14, these understood to being provided in one preferred embodiment as separate and manually assemble-able components. It is also envisioned that the mold halves can be provided as a sandwich mold in which the mold haves are depicted with an interconnecting hinged edge 16 for purposes of ease of opening and closing. In any variant, the mold halves further depict locating profiles (see each of recessed or receiving at 18/20 and projecting or inserting at 22/24) which are defined along opposing and inside face locations of each sandwich half 12 and 14 as depicted in FIG. 2.

The inside facing/opposing surfaces of the upper mold half 12 and lower mold half 14 each further include a mating recessed profile arrangement, see further as shown at 26 along the inside surface of the upper mold half 12 (this for creating the offset flap 8 depicted in the membrane 2). A mating recess profile is formed in the lower mold half 14 and is shown in FIG. 2 by a generally rectangular perimeter extending trench 28.

Also depicted at 30, 32 and 34 are additional details within the trench 28 which correspond to the creation of the configuration details 9 in the flap 8 of FIG. 2. Also shown at 36 and 38 respectively are mating semicircular channels which define a passageway extending from the membrane defining negative cavity and which, upon closing of the sandwich mold and subsequent melt filling of the pre-placed extrusion sheet (resulting from the placement of the heating platens), accommodate the existence of trim or flashing (excess or overfill material) resulting from progressive compressing of the mold halves against the pre-placed extruded sheet and melt-filling of the thermoplastic material during the part forming melt process, as subsequently described.

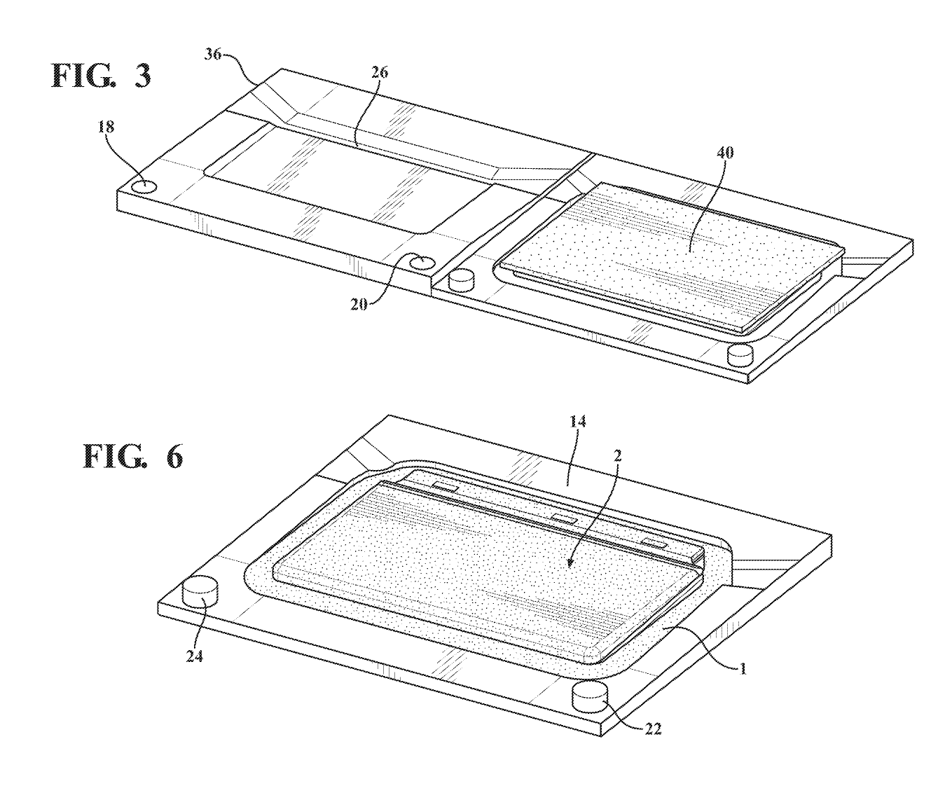

FIG. 3 is a succeeding illustration to FIG. 2 and illustrating an extruded sheet of material 40 which is placed within the lower half 14 of the opened mold and upon its interior profile (overlaying the trench 28). It is understood that the material 40 can include any polymer not limited to any of a thermoplastic, thermoset or composite. Although not shown, the material 40 can also include a polymer within which is embedded any other material (metal fixture/bracket or other non-polymeric component) which substantially retains its original configuration during the formation process. Also, and given the dimensions and placement of the extruded sheet 40 relative to the interior mold surfaces, it is understood that the mold halves may be slightly separated or ajar from one another at initial closure and prior to melting of the sheet 40, at which point the molten material flows into the trench 28 and adjoining flap recess 26 of the inside mold halves and corresponding to the completed sealing/shutting of the mold halves against one another.

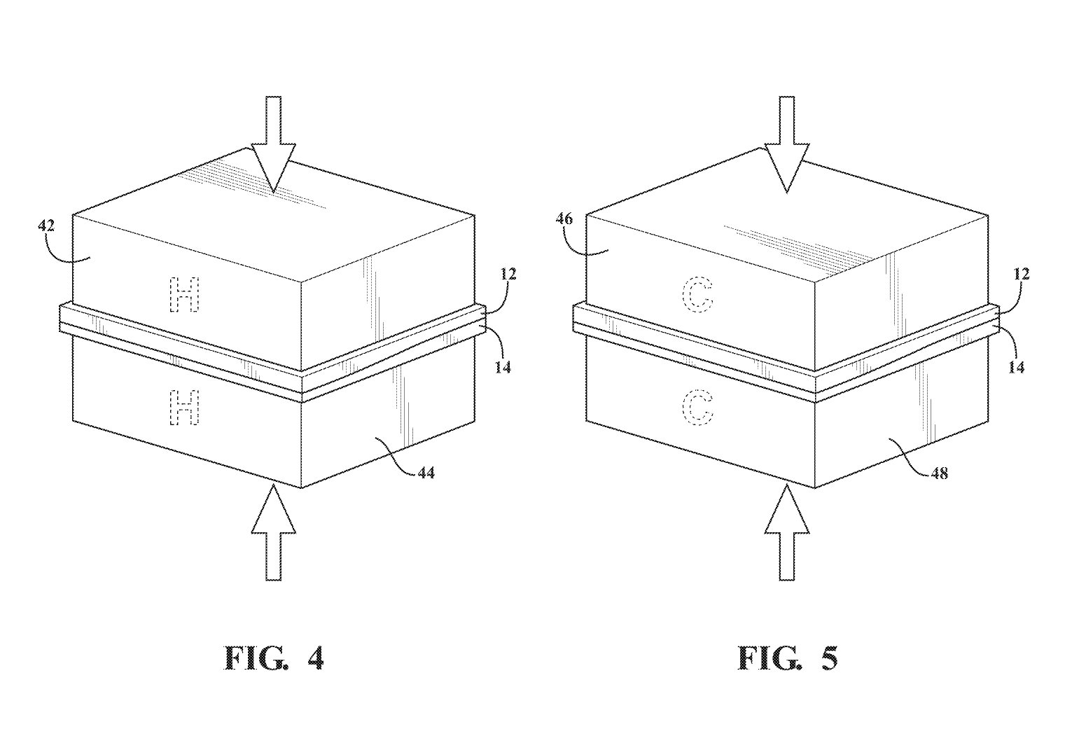

FIG. 4 is an illustration of the mold of FIG. 3 being successively closed, by any of separate assembly or hinged rotated of the upper half into abutting contact with the lower half and thereby sandwiching the extruded sheet therebetween, following which the mold is supported between a pair of upper 42 and lower 44 heated platens, these being pre-heated to the heat temperature of the material and which communicated via conduction through the (metal) mold halves 12/14 to the pre-inserted extruded sheet 40 for melting the same. At this point, the extruded sheet of plastic material (such as a thermoplastic elastomer) is caused to melt into the cavity, with any material overflow escaping through the overflow channel defined by mating recess profiles 36 (associated with the flap recess 26 in the upper mold half 12) and 38 (associated with the encircling trench profile 28 associated with the lower mold half 14).

FIG. 5 is a successive illustration of the mold being transferred to between a successive pair of upper 46 and lower 48 cooled platens and which, upon the extruded sheet previously having been melted into a filling condition with the interior defined cavity, causes the material to solidify. The present invention also contemplates using either a single heating or cooling source in the succeeding steps of FIGS. 4 and 5, and which can include other than heating and cooling platens as may be known in the relevant art.

FIG. 6 is a subsequent mold open condition in which the mold is opened (see remaining lower half 14) and the finished part 2 being ready to be removed, such as following excising of scrap including trim flashing, see at 1, such as which can be accomplished by the pinching action of the dies (such occurring both around the exterior edges of the part and/or associated with the overflow channel). It is further envisioned that the dies can be designed to maintain the flashing contained to the edges of the formed part, such as in places in which it is desired to remove it from the tool when the part is removed, and in such instances a knife or the like can be used for removing the scrap or flashing, such which can be recycled (formable into a future sheet 40 of material) for future use in the process.

As further previously described, FIG. 7 is an illustration of a thin plastic part or membrane, again at 2′ similar to as shown at 2 in FIG. 1, and such as which can be produced by sandwich mold process of the present invention. The present invention contemplates a variety of different parts of relatively thin profile which can be produced with virtually no internal material stresses (unlike those associated with prior art injection molded parts), thereby producing a flatter final produce which will not change shape when exposed to elevated (e.g. environmentally induced) temperatures.

Additional advantages include the machine for producing the part (closed mold halves, hot/cold sets of platens) being of an overall cost lower than associated with injection molding technology, with associated reduction in tooling costs. Further, and due to the sequential nature of the process, the part can be produced at a faster rate than with injection molding. This can further include incorporating the sandwich molds into either of multiple or continuous conveyor style processes, including the sets of heated/cooling platens also being integrated via supporting actuators into the overall production process and being successively and sequentially displaced against and away from contact with the opposite outer surfaces of assembled mold halves to facilitate the successive part melt and cooling/solidifying process.

Accordingly, the mold process and assembly of the present invention improves upon prior art injection molding techniques for producing the thin plastic parts which avoids much of the expense of mold press and tooling, along with the problems of built up internal stresses resulting such as again from injection molding molten plastic into a cold tool (such resulting in curling/warping of the final product). As is further understood, such internal stresses can further result in causing the part to change shape when exposed to elevated temperatures

Having described my invention, other and additional preferred embodiments will become apparent to those skilled in the art to which it pertains, and without departing from the scope of the appended claims.

1. An assembly for producing a plastic part, comprising:
a sandwich mold including an upper half and a lower half, each of said halves having an opposing inner face which, upon assembling, collectively define an interior cavity corresponding to a configuration of the part to be produced;
a polymer material placed upon a lower of said mold halves and prior to assembling said upper mold half;
a heat source communicated to said closed mold to cause said insert sheet to melt into said cavity; and
a cool source subsequently communicated to said closed mold to cause said thermoplastic to harden within said cavity and prior to opening of said mold and removal of the finished part.

2. The assembly as described in claim 1, said upper and lower mold halves each further comprising locating projections and recesses for aligning said halves during closing.

3. The assembly as described in claim 1, further comprising said upper and lower mold halves being hinged along side edges thereof.

4. The assembly as described in claim 1, said heat source further comprising a pair of upper and lower heating platens placed against exterior surfaces of said mold halves.

5. The assembly as described in claim 1, said cool source further comprising a pair of upper and lower cooling platens placed against exterior surfaces of said mold halves.

6. The assembly as described in claim 1, at least one of said upper and lower mold halves further comprising an overfill channel in communication with said cavity.

7. The assembly as described in claim 1, the polymer material further including a sheet of material placed upon said lower mold half.

8. The assembly as described in claim 7, the polymer sheet material further comprising a thermoplastic.

9. A method for producing a plastic part, comprising the steps of:
providing a sandwich mold including an upper half and a lower half, each of the halves having an opposing inner face which, upon assembling, collectively define an interior cavity corresponding to a configuration of the part to be produced;
placing a polymer material upon a lower of the mold halves and prior to assembling the upper mold half;
applying a heat source communicated to the closed mold to cause the material to melt into the cavity; and
subsequently applying a cool source to the closed mold to cause the material to harden within the cavity and prior to opening of the mold and removing the finished part.

10. The method as described in claim 9, further comprising the step of configuring opposing locating projections and recesses into each of the upper and lower mold halves for aligning the halves during closing.

11. The method as described in claim 9, further comprising the step of hinging the upper and lower mold halves along side edges thereof.

12. The method as described in claim 9, the step of applying a heat source further comprising placing a pair of upper and lower heating platens against exterior surfaces of the mold halves.

13. The method as described in claim 9, the step of applying a cool source further comprising placing a pair of upper and lower cooling platens placed against exterior surfaces of the mold halves.

14. The method as described in claim 9, further comprising the step of configuring an overfill channel within at least one of the mold halves and in communication with the cavity.

15. The method as described in claim 9, further comprising the step of removing an edge flashing from the finished part.

16. The method of claim 9, the step of placing the polymer material upon the lower mold half prior to assembly of the upper mold half further comprising placing a solid sheet of a thermoplastic material upon the lower mold half.

17. The method of claim 9, further comprising the step of forming the polymer sheet material from a thermoplastic.
